(19) United States
(12) Patent Application Publication
(10) Pub. No.: US 2026/0313471 A1
(43) Pub. Date: Oct. 8, 2026

(54) DETERMINING USER EQUIPMENT CANDIDATES FOR NETWORK SLICE MANAGEMENT SERVICE/INTERACTIVE DEMAND-BASED NETWORK SLICE MANAGEMENT SERVICE

(71) Applicant: T-Mobile USA, Inc., Bellevue, WA (US)

(72) Inventors: Ryan Christopher Lindstrom, De Soto, KS (US); George Jason Schnellbacher, Leawood, KS (US); Matthew John Starzec, Leesburg, VA (US)

(21) Appl. No.: 19/172,393

(22) Filed: Apr. 7, 2025

(51) Int. Cl. H04W 28/24; H04W 28/08; H04W 48/18

(52) U.S. Cl. CPC H04W 28/24; H04W 28/0967; H04W 48/18

(57) ABSTRACT

The present technology relates to techniques for determining mobile device candidates for a network slice management service. A system detects a mobile device associated with a telecommunications network offering a network slice management service. The system inputs mobile device and network data to an artificial intelligence that determines the mobile device candidates. The present technology further relates to techniques for providing interactive demand-based network slice management services to determined mobile device candidates. A system selects a mobile device candidate operating on a first network slice and obtains demand data corresponding to a second network slice. The system inputs the obtained demand data to an artificial intelligence that determines a first demand amount. The system transmits the first demand amount to the mobile device and, upon receiving an acceptance indication from the mobile device, then transfers the mobile device network activity from the first network slice to the second network slice.

### BACKGROUND

5G network slicing is a network architecture that enables the multiplexing of virtualized and independent logical networks on the same physical network infrastructure. Each network slice is an isolated end-to-end network tailored to fulfill diverse requirements requested by a particular application. The “one-size-fits-all” network paradigm employed in the past mobile networks (2G, 3G and 4G) is no longer suited to efficiently address a market model composed of very different applications like machine-type communication, ultra-reliable low-latency communication and enhanced mobile broadband content delivery. Network slicing emerges as an essential technique in 5G networks to accommodate such different and possibly contrasting quality of service (QoS) requirements exploiting a single physical network infrastructure.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flow diagram of a process for determining user equipment candidates for a network slice management service.

FIG. 4 is a flow diagram of a process for providing an interactive demand-based network slice management service.

FIG. 5 is a block diagram illustrating an example ML system 700, in accordance with one or more embodiments.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to techniques for determining mobile device candidates to provide a network slice management service. The present technology further relates to techniques for providing a particular interactive demand-based network slice management service to the determined mobile device candidates. Telecommunication service providers frequently experience events where an area of their telecommunications network has more demand than supply. For example, a football stadium during a football game places thousands of people in a small area of a telecommunications network. Today, each person at the football stadium likely has a mobile device, if not two or more, that they seek to use at the stadium during the football game (e.g., a fan sending a text or a salesperson completing a transaction). The prevalence of mobile device activity, however, can outpace the supply of the telecommunications network leading to slow network speeds and failed network actions.

5G technologies enable network slicing where telecom operators create multiple virtual networks, or “slices,” within a single physical 5G infrastructure. These slices can be customized to meet specific requirements of different applications, services, or user groups, enabling more efficient use of network resources. These slices can also be used to allocate resources dynamically based on demand. Thus, some types of network activity can be prioritized over other types of network activity to ensure that the prioritized network activity is efficient and successful.

Networks can prioritize network activity based on a first come, first served model. Such a model, however, is inflexible and does not ensure that the needs of the users in the high demand area are properly balanced. For example, if network activity of employees or vendors at a football stadium is not prioritized (i.e., their network activity was initiated after a fan's network activity), the overall fan experience can be degraded (e.g., long concession lines as transactions repeatedly fail). Further, different types of network activity take up more bandwidth of the telecommunications network than others. For example, a fan seeking to send a video of the game can take up a portion of a network slice that could have been used to send multiple texts and handle multiple transactions. Thus, prioritizing network activity on a first come, first served basis can still lead to poor network outcomes.

The disclosed technology addresses network activity prioritization across 5G network slices by identifying mobile device candidates to provide an interactive demand-based network slice management service. In one aspect of the technology, a system detects a mobile device associated with a telecommunications network that offers a network slice management service. The system then obtains data including one or more of: (1) prior use by a user of the mobile device of network slice management services, (2) an entity type associated with the mobile device (e.g., the mobile device is owned by an individual or business), (3) the type of mobile device, (4) location information of the mobile device, (5) a network activity or use of the mobile device, (6) a quality of service experienced by the mobile device, and (7) a network load of the telecommunications network. The system inputs the obtained data to an artificial intelligence which determines, based on the obtained data, a probability that the user of the mobile device will use the network slice management service if the service is offered to the user. Finally, the system initiates the network slice management service with the mobile device in response to the artificial intelligence determining that the probability that the user will use the network slice management service exceeds a particular threshold (e. g, 60% chance).

In another aspect of the technology, a system provides an interactive demand-based network slice management service. First, the system selects a mobile device engaging in a network activity on a first network slice of a telecommunications network to provide the interactive demand-based network slice management service. The service is configured to transfer the network activity of the user equipment (UE) from the first network slice of the telecommunications network to a second network slice of the telecommunications network. Next, the system obtains demand data corresponding to the second network slice including one or more of: (1) a network load of the telecommunications network, (2) location information of the mobile device, and (3) a number of additional mobile devices using the interactive demand-based network slice management service. The system inputs the obtained demand data to an artificial intelligence that determines a first demand amount of the second network slice based on the demand data. The system then transmits the first demand amount, determined by the artificial intelligence, to the mobile device. The system can then receive a first indication from the mobile device corresponding to an acceptance, a rejection, or a counteroffer to the first demand amount (e.g., the mobile device determines the first demand amount is sufficient to warrant transferring its network activity to the second network slice and thereby sends an acceptance). Finally, in response to the first indication from the mobile device corresponding to an acceptance, the system transfers the network activity of the mobile device from the first network slice of the telecommunications network to the second network slice of the telecommunications network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

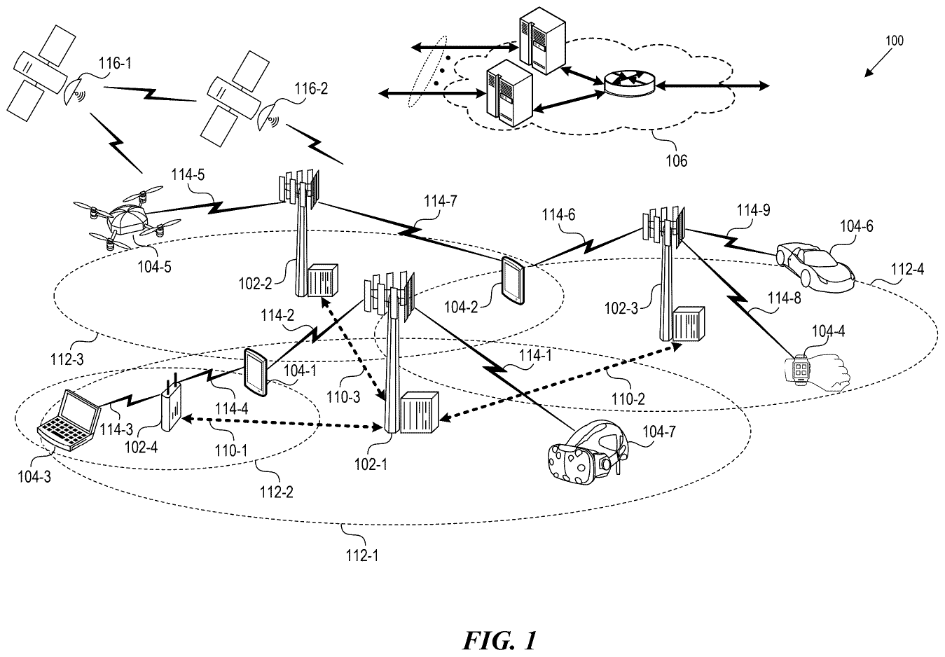

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

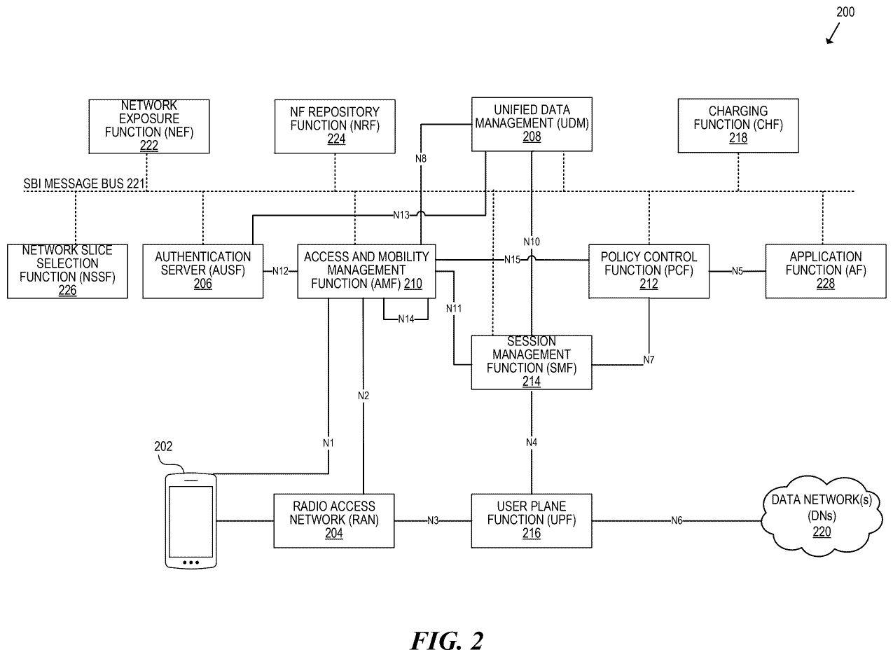

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Determining User Equipment Candidates for Network Slice Management Service

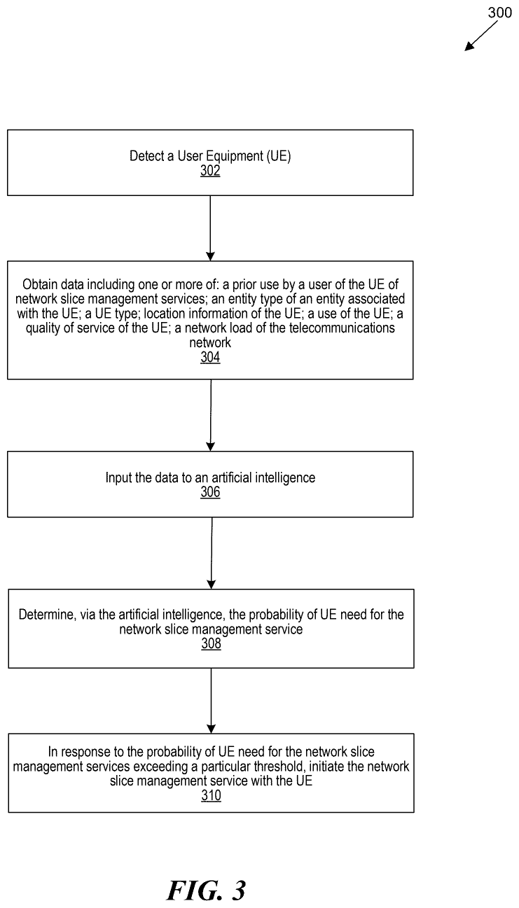

FIG. 3 is a flow diagram of a process 300 for determining user equipment (UE) candidates for a network slice management service. At 302, a system carrying out process 300 detects a UE. The system carrying out process 300 can be a telecommunications network or another computing system. The UE can be a mobile device like a smartphone, a tablet, a laptop, a wearable device, and an IoT device, as well as another device like a mobile hotspot, a router, a modem, a gaming console, etc. The UE can be associated with a telecommunications network that offers a network slice management service. In some embodiments, the network slice management service is configured to move network activity of the UE on a first network slice of the telecommunications network to a second network slice of the telecommunications network. In other embodiments, the network slice management service is configured to simply prioritize the network activity of the UE on the first network slice of the telecommunications network.

The system carrying out process 300 can detect the UE by sensing that the UE is within a service area of the telecommunications network associated with the UE. In the disclosed technology, the system can sense that the UE is within the service area of the telecommunications network associated with the UE by a cellular network registration signal, a location area update, a paging message, a signal strength measurement, a Global Positioning System (GPS) signal, a Wi-Fi signal, a Bluetooth signal, etc. For example, the system can sense that the UE is within the service area of the telecommunications network associated with the UE by receiving a location area update signal from the UE as the UE moves locations.

The system carrying out process 300 can also detect the UE by receiving a request from a user of the UE to initiate the network slice management service. For example, a user at a crowded football stadium intending to send a large video file can preemptively request that the telecommunications network associated with their UE provide the network slice management service to ensure their large video file successfully sends.

At 304, the system can obtain data that includes one or more of: a prior use by a user of the UE of network slice management services, (1) an entity type of an entity associated with the UE, (2) a UE type, (3) location information of the UE, (4) a use of the UE, (5) a quality of service of the UE, and (6) a network load of the telecommunications network. This data can be used by an artificial intelligence to determine the probability of UE need for the network slice management service (as described with respect to steps 306 and 308). The probability of UE need for the network slice management service can determine whether the UE is a candidate for the service (as described with respect to step 310).

First, in the disclosed technology, UEs can be operated by a variety of entity types including businesses, individuals, family members, and other types of user categories recorded by the telecommunications network. In some embodiments, the system can determine the entity type by identifying a profile (or user profile data) of the user associated with the telecommunications network. For example, the system can determine that the UE is linked to an individual by obtaining their user profile data associated with the telecommunications network and identifying that the user has purchased a type of telecommunications network plan for an individual. Entity type can impact the probability of UE need for the network slice management service because, for example, a business operating at a football stadium may require that their network activity be prioritized to successfully deliver their services to fans.

Second, the system can obtain data related to the UE type. The data related to the UE type can include 5G capability, Radio Frequency (RF) performance, device components (e.g., number of MIMO antennas), etc. For example, particular UE types (e.g., old smartphones without 5G capability) can be incompatible with the network slice management service. As such, the system can use the UE type to determine whether the detected UE is compatible or incompatible with the network slice management service and therefore determine whether the UE is a candidate for the service. An incompatible device can lead the artificial intelligence described below to determine a low (or zero) probability of UE need for the network slice management service.

Third, the system can obtain data related to location information of the UE. The data related to location information can include a location of the UE, an event occurring at the location of the UE, coordinates of a particular geofence that enables the network slice management service relative to the location of the UE, etc. The system can identify the location of the UE through a variety of methods including device triangulation, GPS location identification, and a Wi-Fi positioning system. In some embodiments, the network slice management service may only be offered by the telecommunications network in select locations. For example, the telecommunications network, in anticipation of a football game, can dictate that the network slice management service will be offered within a particular radius of the football stadium. Or, for example, the telecommunications network can establish a particular geofence (e.g., a geofence around a football stadium or a parade) that enables the network slice management service within the geofence. In these examples, when the system identifies that the UE is located within the defined radius of the football stadium or within the particular geofence, the artificial intelligence described below can determine that the UE has a higher probability of need for the network slice management service than another UE outside of the defined radius or particular geofence.

In some embodiments, the system can pull or scrape data from the internet to identify events, event locations, and event times. In such embodiments, the system can record the events and match the event location and time to a location and time of the UE. If the UE location and time align with the identified event location and time, the artificial intelligence described below can determine that the UE has a higher probability of need for the network slice management service.

Fourth, the system can obtain data related to a use of the UE. The data related to a use of the UE can comprise identifying the network traffic type of the use of the UE. The types of network traffic can include audio communication, video communication, text communication, a point-of-sale activity, a livestream, a data upload, and a data download. The probability that a UE will need the network slice management service can depend on the type of network traffic. For example, as compared to other network traffic types, video uploading can be highly bandwidth intensive. As such, a user seeking to upload a video through the telecommunications network can struggle to successfully upload the video in a high network demand location. Thus, the user seeking to upload the video can be more likely to use the network slice management service to move the video upload to a higher priority network slice or a dedicated video upload slice than a user in the same high network demand location seeking to send a lower bandwidth intensive text message. In some embodiments, the telecommunications network can restrict the offering of the network slice management service to one or more types of network traffic thereby reducing the probability that UEs engaging in other network traffic types will need the network slice management service.

Fifth, the system can obtain data related to a quality of service of the UE. The data related to a quality of service of the UE can include packet loss data of the UE, a latency time of the UE, an error rate of the data transmission from the UE, and a throughput of the UE. For example, a UE experiencing high packet loss can likely benefit from network slice management that prioritizes the UE network activity. Thus, the artificial intelligence described below can determine that the UE experiencing high packet loss has a higher probability of need for the network slice management service than a UE experiencing low packet loss.

The quality of service of the UE can be identified by the UE or by the telecommunications network. In some embodiments, the UE identifies its quality of service by running tests on the UE and communicating the test results to the telecommunications network (e.g., communicating through a software application of the UE).

Finally, the system can obtain data related to a network load of the telecommunications network. The data related to a network load of the telecommunications network can include a number of users registered to the telecommunications network proximate to the UE, a number of Bluetooth low energy (BLE) signals proximate to the UE, and a utilization of the telecommunications network. A large number of users registered to the telecommunications network proximate to the UE can increase the likelihood that network demand will exceed the network supply, thereby increasing the probability that the UE will need the network slice management service. Similarly, a large number of BLE signals proximate to the UE can increase the likelihood that the UE is in a crowded area (e.g., a football stadium during a football game) where network demand will exceed the network supply, thereby increasing the probability that the UE will need the network slice management service. Additionally, high network utilization can indicate that demand is exceeding supply, thereby increasing the probability the UEs operating on the network will need network slice management services.

In some embodiments, the system can identify utilization of the telecommunications network by resource block utilization. For example, a high percentage of available resource blocks in use can indicate a high network utilization. In other embodiments, the system can determine utilization of the telecommunications network by bit rate. For example, a low actual bit rate (as measured by the telecommunications network) relative to a target bit rate of the telecommunications network can indicate high network utilization.

At 306, the system can input the obtained data to an artificial intelligence. The artificial intelligence can be trained to determine a probability (e.g., 60%) of UE need for the network slice management services based on the obtained data. At 308, the system can determine, via the artificial intelligence, the probability of UE need for the network slice management service.

At 310, in response to the probability of UE need for the network slice management services exceeding a particular threshold, the system can initiate the network slice management service with the UE. In some embodiments, the particular threshold can be pre-set by operators of the telecommunications network. For example, the telecommunications network operators can determine that a UE at a probability greater than 50% of UE need for the network slice management services is an appropriate candidate for the service and thus the system should initiate the service with the UE.

### Interactive Demand-Based Network Slice Management Service

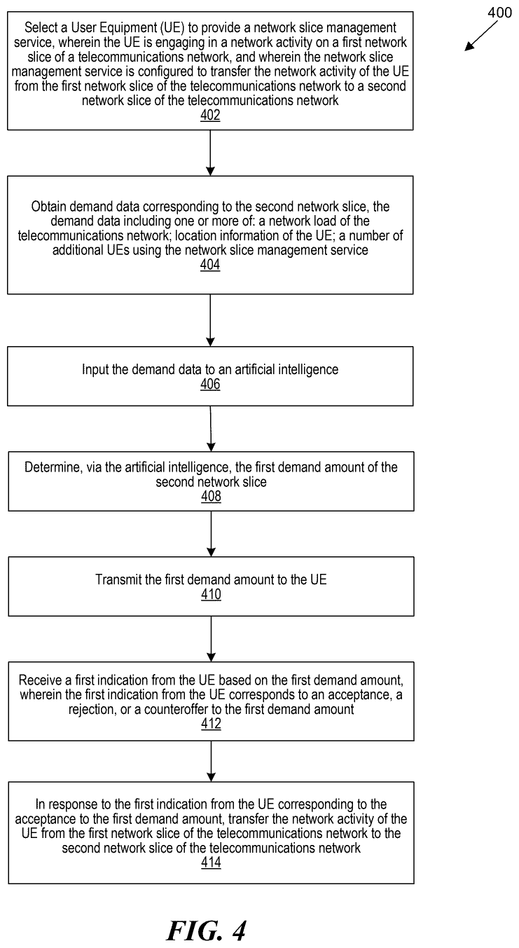

FIG. 4 is a flow diagram of a process 400 for providing an interactive demand-based network slice management service. At 402, a system carrying out process 400 can select a UE to provide a network slice management service. The system carrying out process 400 can be a telecommunications network or another computing system. The UE can be a mobile device like a smartphone, a tablet, a laptop, a wearable device, and an IoT device, as well as another device like a mobile hotspot, a router, a modem, a gaming console, etc. The UE can be engaging in a network activity on a first network slice of a telecommunications network. In some embodiments, the network slice management service is configured to transfer the network activity of the UE from the first network slice of the telecommunications network to a second network slice of the telecommunications network. In other embodiments, the network slice management service is configured to prioritize the network activity of the UE on the first network slice of the telecommunications network. In yet further embodiments, the network slice management service can be an auction-based network slice management service configured to transfer the network activity of the UE from the first network slice of the telecommunications network to the second network slice of the telecommunications network. In such embodiments, the system carrying out process 400 can operate an auction between UEs seeking the network slice management service to determine which of the UEs will have their network activity transferred from the first network slice of the telecommunications network to the second network slice.

The system carrying out process 400 can select the UE to provide the network slice management service via a second artificial intelligence distinct from the artificial intelligence described with respect to steps 406 and 408 below. In some embodiments, the system carrying out process 400 can select the UE by the process 300 described with respect to FIG. 3 above.

At 404, the system carrying out process 400 can obtain demand data corresponding to the second network slice. As described above, the network slice management service allows a telecommunications network to better prioritize its network resources. Thus, if the second network slice is in high demand or is already crowded, moving a UE's network activity from the first slice to the second slice could fail to effectively prioritize the network resources of the telecommunications network. Therefore, obtaining demand data corresponding to the second network slice allows the system to identify whether a UE in need of the network slice management service will benefit from having its network activity transferred to the second slice. The demand data corresponding to the second network slice also allows the system to identify a demand amount (e.g., a price for the user of the UE to transfer their network activity from the first network slice to the second network slice) to moderate the amount of network activity transferred to the second slice.

In the disclosed technology, the demand data corresponding to the second network slice can include (1) a network load of the telecommunications network, (2) a location information of the UE, and (3) a number of additional UEs using the network slice management service. In some embodiments, the system carrying out process 400 obtains the network load of the telecommunications network by identifying one or more of a number of users registered to the telecommunications network proximate to the UE, a number of BLE signals proximate to the UE, and a utilization of the telecommunications network. A large number of users registered to the telecommunications network proximate to the UE can indicate an increased demand for the network slice management service and therefore increased demand for transferring UE network activity to the second network slice. Similarly, a large number of BLE signals proximate to the UE can indicate that the UE is in a crowded area (e.g., a football stadium during a football game) where network demand will exceed the network supply, thereby increasing demand for the network slice management service and for transferring UE network activity to the second network slice.

Additionally, high network utilization can indicate an increased demand for the network slice management service and therefore increased demand for transferring UE network activity to the second network slice. In some embodiments, the system can determine utilization of the telecommunications network by identifying resource block utilization. For example, a high percentage of available resource blocks in use can indicate a high network utilization. In other embodiments, the system can determine utilization of the telecommunications network by identifying a bit rate. For example, a low actual bit rate (as measured by the telecommunications network) relative to a target bit rate of the telecommunications network can indicate high network utilization.

In some embodiments, the system carrying out process 400 obtains the location information of the UE by identifying one or more of a location of the UE, an event occurring at the location of the UE, and coordinates of a particular geofence that enables the network slice management service relative to the location of the UE. The system can identify the location of the UE through a variety of methods including device triangulation, GPS location identification, and a Wi-Fi positioning system. In some embodiments, the location of the UE can indicate an increased demand for the second network slice. For example, if the second network slice is tailored to transmitting videos across the telecommunications network and a particular location frequently uses the second network slice to do so, the system can identify that a UE in the particular location has an increased demand for the second network slice.

In other embodiments, an event occurring at the location of the UE may indicate an increased demand for the second network slice. For example, a UE at a football stadium during a sold-out football game event can lead to an increased demand for a second network slice. Similarly, in yet further embodiments, identifying that a UE is within a particular geofence enabling network slice management services can indicate an increased demand for transferring UE network activity to the second network slice given that such a transfer is available within that particular geofence. In some embodiments, the system can pull or scrape data from the internet to identify events, event locations, and event times. In such embodiments, the system can record the events and match the event location and time to a location and time of the UE. If the UE location and time align with the identified event location and time, the artificial intelligence described below can determine that the second network slice has a higher demand.

Finally, in some embodiments, the system carrying out process 400 obtains a number of additional UEs using the network slice management service. Identifying the number of additional UEs using the network slice management service (i.e., the number of additional UEs seeking to transfer their network activity from a network slice to the second network slice) can indicate the demand for the second network slice. A large number of additional UEs using the network slice management service can indicate high demand for the second network slice, whereas a small number of additional UEs using the network slice management service can indicate a low demand for the second network slice. Further, in other embodiments, the system can obtain a demand amount from additional UEs using the network slice management service. As described below, the disclosed technology can use the obtained data to determine a first demand amount for the second network slice that will be sent to the UE. In some embodiments, the system can identify a second demand amount sent to an additional UE prior to determining the first demand amount for the UE and include that amount in the obtained data to augment the first demand amount determined by the artificial intelligence and sent to the UE. For example, if an additional UE previously received a demand amount of $1 and chose to transfer its network activity to the second network slice, the system can obtain that demand amount data and determine that the first demand amount to send to the UE should be a demand amount of $1.5.

At 406, the system carrying out process 400 can input the demand data to an artificial intelligence trained to determine a first demand amount of the second network slice based on the demand data. In some embodiments, the first demand amount can comprise a price that the user of the UE must pay for the network slice management service to transfer the network activity of the UE on the first network slice to the second network slice. At 408, the system, via the artificial intelligence, can determine the first demand amount of the second network slice based on the demand data input to the artificial intelligence. Then, at 410, the system can transmit the first demand amount to the UE.

At 412, the system can receive a first indication from the UE based on the first demand amount. The first indication from the UE can correspond to an acceptance, a rejection, or a counteroffer to the first demand amount. For example, the UE can accept a demand amount of $1.5, reject the demand amount of $1.5, or submit a counteroffer (e.g., $1.25).

At 414, in response to the first indication from the UE corresponding to an acceptance to the first demand amount, the system can transfer the network activity of the UE from the first network slice of the telecommunications network to the second network slice of the telecommunications network. In embodiments where the network slice management service simply prioritizes the UE network activity on the first network slice, in response to the first indication from the UE corresponding to an acceptance to the first demand amount, the system prioritizes the UE network activity on the first network slice.

In some embodiments, in response to the first indication from the UE corresponding to a counteroffer to the first demand amount, the system can determine, via the artificial intelligence, another demand amount of the second network slice following steps 404 through 408 above. Then, the system can transmit the new demand amount to the UE and receive an indication from the UE corresponding to an acceptance, a rejection, or another counteroffer to the new demand amount. Upon acceptance to the new demand amount, the system can transfer the network activity of the UE from the first network slice of the telecommunications network to the second network slice of the telecommunications network. In other embodiments, in response to the first indication from the UE corresponding to a rejection to the first demand amount, the system can terminate the network slice management service at the UE.

### ML System

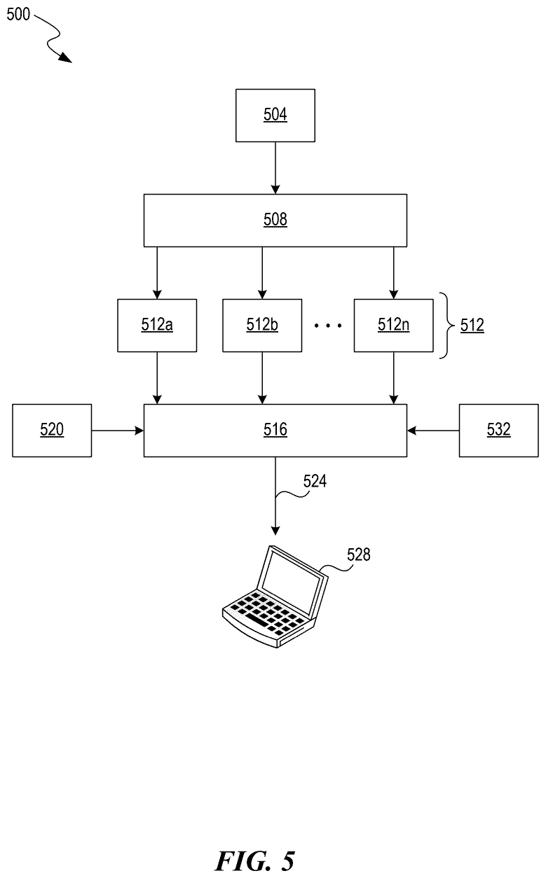

FIG. 5 is a block diagram illustrating an example ML system 500, in accordance with one or more embodiments. The ML system 500 can implement one or more components of the computer systems and apparatuses discussed herein. Although illustrated in a particular configuration, different embodiments of the ML system 500 include different and/or additional components and are connected in different ways. The ML system 500 is sometimes referred to as an ML module.

The ML system 500 includes a feature extraction module 508 implemented using components of an example computer system, as described herein. In some embodiments, the feature extraction module 508 extracts a feature vector 512 from input data 504. The feature vector 512 includes features 512a, 512b, . . . , 512n. The feature extraction module 508 reduces the redundancy in the input data 504, for example, repetitive data values, to transform the input data 504 into the reduced set of features 512, for example, features 512a, 512b, . . . , 512n. The feature vector 512 contains the relevant information from the input data 504, such that events or data value thresholds of interest are identified by the ML model 516 by using a reduced representation. In some example embodiments, the following dimensionality reduction techniques are used by the feature extraction module 508: independent component analysis, Isomap, principal component analysis (PCA), latent semantic analysis, partial least squares, kernel PCA, multifactor dimensionality reduction, nonlinear dimensionality reduction, multilinear PCA, multilinear subspace learning, semidefinite embedding, autoencoder, and deep feature synthesis.

In alternate embodiments, the ML model 516 performs deep learning (also known as deep structured learning or hierarchical learning) directly on the input data 504 to learn data representations, as opposed to using task-specific algorithms. In deep learning, no explicit feature extraction is performed; the features 512 are implicitly extracted by the ML system 500. For example, the ML model 516 uses a cascade of multiple layers of nonlinear processing units for implicit feature extraction and transformation. Each successive layer uses the output from the previous layer as input. The ML model 516 thus learns in supervised (e.g., classification) and/or unsupervised (e.g., pattern analysis) modes. The ML model 516 learns multiple levels of representations that correspond to different levels of abstraction, wherein the different levels form a hierarchy of concepts. The multiple levels of representation configure the ML model 516 to differentiate features of interest from background features.

In alternative example embodiments, the ML model 516, for example, in the form of a convolutional neural network (CNN), generates the output 524, without the need for feature extraction, directly from the input data 504. The output 524 is provided to the computer device 528. The computer device 528 is a server, computer, tablet, smartphone, smart speaker, etc., implemented using components of an example computer system, as described herein. In some embodiments, the steps performed by the ML system 500 are stored in memory on the computer device 528 for execution. In other embodiments, the output 524 is displayed on an apparatus or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 516 is a CNN that includes both convolutional layers and max pooling layers. For example, the architecture of the ML model 516 is “fully convolutional,” which means that variable sized sensor data vectors are fed into it. For convolutional layers, the ML model 516 specifies a kernel size, a stride of the convolution, and an amount of zero padding applied to the input of that layer. For the pooling layers, the ML model 516 specifies the kernel size and stride of the pooling.

In some embodiments, the ML system 500 trains the ML model 516, based on the training data 520, to correlate the feature vector 512 to expected outputs in the training data 520. As part of the training of the ML model 516, the ML system 500 forms a training set of features and training labels by identifying a positive training set of features that have been determined to have a desired property in question, and, in some embodiments, forms a negative training set of features that lack the property in question.

The ML system 500 applies ML techniques to train the ML model 516, such that when applied to the feature vector 512, output indications of whether the feature vector 512 has an associated desired property or properties, such as a probability that the feature vector 512 has a particular Boolean property, or an estimated value of a scalar property. In embodiments, the ML system 500 further applies dimensionality reduction (e.g., via linear discriminant analysis (LDA), PCA, or the like) to reduce the amount of data in the feature vector 512 to a smaller, more representative set of data.

In embodiments, the ML system 500 uses supervised ML to train the ML model 516, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 532 is formed of additional features, other than those in the training data 520, which have already been determined to have or to lack the property in question. The ML system 500 applies the trained ML model 516 to the features of the validation set 532 to quantify the accuracy of the ML model 516. Common metrics applied in accuracy measurement include Precision and Recall, where Precision refers to a number of results the ML model 516 correctly predicted out of the total it predicted, and Recall is a number of results the ML model 516 correctly predicted out of the total number of features that had the desired property in question. In some embodiments, the ML system 500 iteratively retrains the ML model 516 until the occurrence of a stopping condition, such as the accuracy measurement indication that the ML model 516 is sufficiently accurate, or a number of training rounds having taken place. In embodiments, the validation set 532 includes data corresponding to confirmed locations, dates, times, activities, or combinations thereof. This allows the detected values to be validated using the validation set 532. The validation set 532 is generated based on the analysis to be performed.

### Computer System

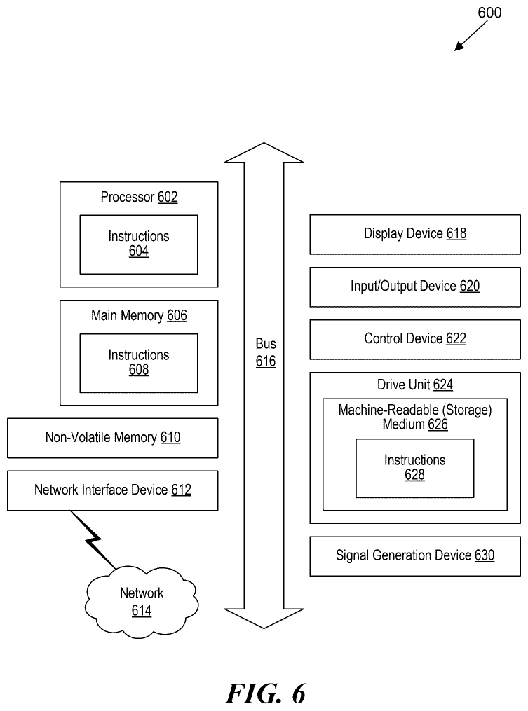

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to:
select a User Equipment (UE) to provide a network slice management service,
wherein the UE is engaging in a network activity on a first network slice of a telecommunications network;
wherein the network slice management service is configured to transfer the network activity of the UE from the first network slice of the telecommunications network to a second network slice of the telecommunications network;
obtain demand data corresponding to the second network slice, the demand data including one or more of:
a network load of the telecommunications network;
location information of the UE; or
a number of additional UEs using the network slice management service;
input the demand data to an artificial intelligence,
wherein the artificial intelligence is trained to determine a first demand amount of the second network slice based on the demand data;
determine, via the artificial intelligence, the first demand amount of the second network slice;
transmit the first demand amount to the UE;
receive a first indication from the UE based on the first demand amount,
wherein the first indication from the UE corresponds to an acceptance, a rejection, or a counteroffer to the first demand amount; and
in response to the first indication from the UE corresponding to the acceptance to the first demand amount, transfer the network activity of the UE from the first network slice of the telecommunications network to the second network slice of the telecommunications network.

2. The non-transitory, computer-readable storage medium of claim 1, the system being further caused to:
select the UE to provide the network slice management service via a second artificial intelligence.

3. The non-transitory, computer-readable storage medium of claim 1, wherein the network slice management service is an auction-based network slice management service configured to transfer the network activity of the UE from the first network slice of the telecommunications network to the second network slice of the telecommunications network.

4. The non-transitory, computer-readable storage medium of claim 1, wherein the network slice management service is configured to prioritize the network activity of the UE on the first network slice of the telecommunications network.

5. The non-transitory, computer-readable storage medium of claim 1, wherein to obtain the demand data corresponding to the second network slice the system is further caused to:
identify a second demand amount, the second demand amount determined via the artificial intelligence prior to the first demand amount,
wherein the second demand amount is based on the demand data and a second indication from an additional UE.

6. The non-transitory, computer-readable storage medium of claim 1, wherein to obtain the network load of the telecommunications network the system is further caused to:
identify one or more of:
a number of users registered to the telecommunications network proximate to the UE; or
a utilization of the telecommunications network.

7. The non-transitory, computer-readable storage medium of claim 1, wherein to obtain the location information of the UE the system is further caused to:
identify one or more of:
a location of the UE;
an event occurring at the location of the UE; or
coordinates of a particular geofence that enables the network slice management service relative to the location of the UE.

8. The non-transitory, computer-readable storage medium of claim 1, the system being further caused to:
in response to the first indication from the UE corresponding to the counteroffer to the first demand amount, determine, via the artificial intelligence, a third demand amount of the second network slice;
transmit the third demand amount to the UE;
receive a third indication from the UE based on the third demand amount,
wherein the third indication from the UE corresponds to an acceptance, a rejection, or a counteroffer to the third demand amount; and
in response to the third indication from the UE corresponding to the acceptance to the third demand amount, transfer the network activity of the UE from the first network slice of the telecommunications network to the second network slice of the telecommunications network.

9. The non-transitory, computer-readable storage medium of claim 1, the system being further caused to:
in response to the first indication from the UE corresponding to the rejection to the first demand amount, terminate the network slice management service at the UE.

10. A system comprising:
at least one hardware processor; and
at least one non-transitory memory storing instructions, which, when executed by the at least one hardware processor, cause the system to:
select a mobile device to provide a network slice management service,
wherein the mobile device is engaging in a network activity on a first network slice of a telecommunications network;
wherein the network slice management service is configured to transfer the network activity of the mobile device from the first network slice of the telecommunications network to a second network slice of the telecommunications network;
obtain demand data corresponding to the second network slice, the demand data including one or more of:
a network load of the telecommunications network;
location information of the mobile device; or
a number of additional mobile devices using the network slice management service;
input the demand data to an artificial intelligence,
wherein the artificial intelligence is trained to determine a first demand amount of the second network slice based on the demand data;
determine, via the artificial intelligence, the first demand amount of the second network slice;
transmit the first demand amount to the mobile device;
receive a first indication from the mobile device based on the first demand amount,
wherein the first indication from the mobile device corresponds to an acceptance, a rejection, or a counteroffer to the first demand amount; and
in response to the first indication from the mobile device corresponding to the acceptance to the first demand amount, transfer the network activity of the mobile device from the first network slice of the telecommunications network to the second network slice of the telecommunications network.

11. The system of claim 10, wherein the network slice management service is an auction-based network slice management service configured to transfer the network activity of the mobile device from the first network slice of the telecommunications network to the second network slice of the telecommunications network.

12. The system of claim 10, wherein the network slice management service is configured to prioritize the network activity of the mobile device on the first network slice of the telecommunications network.

13. The system of claim 10, wherein to obtain the demand data corresponding to the second network slice the system is further caused to:
identify a second demand amount, the second demand amount determined via the artificial intelligence prior to the first demand amount,
wherein the second demand amount is based on the demand data and a second indication from an additional mobile device.

14. The system of claim 10, wherein to obtain the network load of the telecommunications network the system is further caused to:
identify one or more of:
a number of users registered to the telecommunications network proximate to the mobile device; or
a utilization of the telecommunications network.

15. The system of claim 10, wherein to obtain the location information of the mobile device the system is further caused to:
identify one or more of:
a location of the mobile device;
an event occurring at the location of the mobile device; or
coordinates of a particular geofence that enables the network slice management service relative to the location of the mobile device.

16. The system of claim 10, the system being further caused to:
in response to the first indication from the mobile device corresponding to the counteroffer to the first demand amount, determine, via the artificial intelligence, a third demand amount of the second network slice;
transmit the third demand amount to the mobile device;
receive a third indication from the mobile device based on the third demand amount,
wherein the third indication from the mobile device corresponds to an acceptance, a rejection, or a counteroffer to the third demand amount; and
in response to the third indication from the mobile device corresponding to the acceptance to the third demand amount, transfer the network activity of the mobile device from the first network slice of the telecommunications network to the second network slice of the telecommunications network.

17. A method comprising:
selecting a User Equipment (UE) to provide a network slice management service,
wherein the UE is engaging in a network activity on a first network slice of a telecommunications network;
wherein the network slice management service is configured to transfer the network activity of the UE from the first network slice of the telecommunications network to a second network slice of the telecommunications network;
obtaining demand data corresponding to the second network slice, the demand data including one or more of:
a network load of the telecommunications network;
location information of the UE; or
a number of additional UEs using the network slice management service;
inputting the demand data to an artificial intelligence,
wherein the artificial intelligence is trained to determine a first demand amount of the second network slice based on the demand data;
determining, via the artificial intelligence, the first demand amount of the second network slice;
transmitting the first demand amount to the UE;
receiving a first indication from the UE based on the first demand amount,
wherein the first indication from the UE corresponds to an acceptance, a rejection, or a counteroffer to the first demand amount; and
in response to the first indication from the UE corresponding to the acceptance to the first demand amount, transferring the network activity of the UE from the first network slice of the telecommunications network to the second network slice of the telecommunications network.

18. The method of claim 17, wherein the network slice management service is an auction-based network slice management service configured to transfer the network activity of the UE from the first network slice of the telecommunications network to the second network slice of the telecommunications network.

19. The method of claim 17, wherein obtaining the demand data corresponding to the second network slice further comprises:
identifying a second demand amount, the second demand amount determined via the artificial intelligence prior to the first demand amount,
wherein the second demand amount is based on the demand data and a second indication from an additional UE.

20. The method of claim 17, further comprising:
in response to the first indication from the UE corresponding to the counteroffer to the first demand amount, determining, via the artificial intelligence, a third demand amount of the second network slice;
transmitting the third demand amount to the UE;
receiving a third indication from the UE based on the third demand amount,
wherein the third indication from the UE corresponds to an acceptance, a rejection, or a counteroffer to the third demand amount; and
in response to the third indication from the UE corresponding to the acceptance to the third demand amount, transferring the network activity of the UE from the first network slice of the telecommunications network to the second network slice of the telecommunications network.
